(19) United States
(12) Patent Application Publication
(10) Pub. No.: US 2004/0047557 A1
(43) Pub. Date: Mar. 11, 2004

(54) Microlens array, optical module using the microlens array, and method for determining position of optical module

(76) Inventors: Yasufumi Muto, Osaka-shi (JP); Yoshiro Sato, Osaka-shi (JP); Yoshihide Yasuda, Osaka-shi (JP)

Correspondence Address: POSZ & BETHARDS, PLC, 11250 ROGER BACON DRIVE, SUITE 10, RESTON, VA, 20190, US

(21) Appl. No.: 10/653,076

(22) Filed: Sep. 3, 2003

(30) Foreign Application Priority Data
Sep. 9, 2002 (JP) 2002-263341

(51) Int. Cl. G02B 6/32

(52) U.S. Cl. 385/33

(57) ABSTRACT

A transparent lens substrate includes a first end and a second end, which are on opposite sides of the lens substrate. The second end is inclined with respect to the first end. Microlenses are formed on the lens substrate to be located either inside or outside the first end. Each microlens has an optical axis. The optical axis of each microlens intersects the first end and the second end of the lens substrate at a first intersection and a second intersection. The distance between the first and second intersections defines a substrate thickness, and the substrate thickness varies depending on each microlens.

### BACKGROUND OF THE INVENTION

The present invention relates to a microlens array, an optical module that uses the microlens array, and a method for determining the position of the optical module.

An optical module that includes a flat microlens and an optical fiber has been proposed. A microlens main body is formed on one side of the flat microlens. An outgoing end of the optical fiber is inclined with respect to a central axis of a core of the optical fiber. Such an optical module is used for an optical communication. The optical module couples the outgoing light from the optical fiber to other part, such as another optical fiber or a receiver, by the flat microlens.

Such an optical module is used for a collimator optical device. In the collimator optical device, an optical function element, such as an optical filter, an optical isolator, an optical switch, and an optical modulator, is inserted between a pair of the above mentioned optical modules. The collimator optical device has a function to apply a predetermined effect on light that is transmitted through an optical fiber on an incoming side, and to couple the light to an optical fiber on an outgoing side.

The collimator optical device is required to have a long collimator length between the pair of optical modules and a high coupling efficiency to use a physically large optical function element, such as a large scale matrix switch. To satisfy such requirements, when manufacturing the optical module, the distance between the microlens and the optical fiber, that is, the lens to optical fiber distance needs to be set accurately to a desired value.

### SUMMARY OF THE INVENTION

Accordingly, it is an objective of the present invention to provide a microlens array that can be manufactured with a high accuracy, an optical module that uses the microlens array, and a method for determining the position of the optical module.

To achieve the above objective, the present invention provides a microlens array, which includes a transparent lens substrate and microlenses. The transparent lens substrate has a first end and a second end, which are on opposite sides of the lens substrate. The second end is inclined with respect to the first end. The microlenses are formed on the lens substrate to be located either inside or outside the first end. Each microlens has an optical axis. The optical axis of each microlens intersects with the first end and the second end of the lens substrate at a first intersection and a second intersection. The distance between the first and second intersections defines a substrate thickness. The substrate thickness differs depending on each microlens.

The present invention also provides an optical module, which includes a microlens array and an optical fiber. The microlens array and the optical fiber are located apart from each other by a desired lens to optical fiber distance. The microlens array includes a transparent lens substrate and microlenses. The transparent lens substrate has a first end and a second end, which are on opposite sides of the lens substrate. The second end is inclined with respect to the first end. The microlenses are formed on the lens substrate to be located either inside or outside the first end. Each microlens has an optical axis. The optical axis of each microlens intersects with the first end and the second end of the lens substrate at a first intersection and a second intersection. The distance between the first and second intersections defines a substrate thickness. The substrate thickness varies depending on each microlens. One of the microlenses is selected to optimize the substrate thickness. The position of the optical fiber is determined with respect to the selected microlens.

A further aspect of the present invention is a method for determining the position of a microlens array and an optical fiber such that the microlens array and the optical fiber are apart from each other by a desired distance. The method comprising: preparing the microlens array, wherein the microlens array includes a plurality of microlenses, which are located either inside or outside a first end of a lens substrate, wherein each microlens has an optical axis, wherein the optical axis of each microlens intersects the first end and a second end of the lens substrate at a first intersection and a second intersection, wherein the distance between the first and second intersections defines a substrate thickness, and wherein the substrate thickness varies depending on each microlens; selecting one of the microlenses to optimize the substrate thickness; and determining the position of the optical fiber with respect to the selected microlens.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram illustrating an optical module according to a first embodiment of the present invention;

FIG. 2 is a front view illustrating a microlens array of the optical module shown in FIG. 1;

FIG. 3 is an explanatory diagram illustrating a method for determining the position of the optical module shown in FIG. 1;

FIG. 4 is a schematic diagram illustrating an optical module according to a second embodiment;

FIG. 5 is a schematic diagram illustrating an optical module according to a third embodiment;

FIG. 6 is a schematic diagram illustrating an optical module according to a fourth embodiment;

FIG. 7 is an explanatory diagram illustrating a method for determining the position of the optical module; and

FIG. 8 is an explanatory diagram illustrating a method for determining the position of the optical module.

### DETAILED DESCRIPTION OF THE PREFERRED EMBODIMENTS

An optical module according to embodiments of the present invention will now be described with reference to drawings. The optical module uses a microlens array.

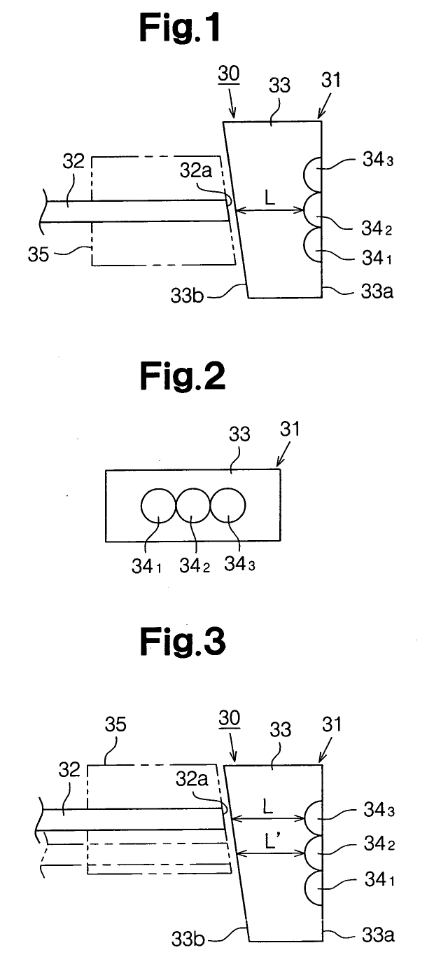

FIGS. 1 and 2 show an optical module 30 according to a first embodiment. The optical module 30 includes a microlens array, which is a flat microlens array 31 in the first embodiment, and a single mode optical fiber, which is an optical fiber 32 in the first embodiment.

The flat microlens array 31 is constituted by a transparent lens substrate 33. Three microlenses 34₁ to 34₃ are formed on the inner side of a right end (first end) 33a of the lens substrate 33. The right end 33a of the lens substrate 33 is perpendicular to an optical axis. A left end of the lens substrate 33 is inclined with respect to the right end 33a forming an inclined surface (second end) 33b. That is, the right end 33a of the lens substrate 33 is a flat surface that is perpendicular to the optical axis of each of the microlenses 34₁ to 34₃. On the other hand, the inclined surface 33b of the lens substrate 33 is polished to be inclined by a predetermined angle, for example, eight degrees, with respect to the right end 33a to prevent a reflected light from returning to a light source.

In the flat microlens array 31₁ the microlenses 34₁ to 34₃ are arranged such that the distance between intersections of the optical axis of each microlens with the right end 33a and the inclined surface 33b of the lens substrate 33, that is, the substrate thickness, are different from each other.

Since the inclined surface 33b is formed, the substrate thickness of the lens substrate 33 at the upper side is greater than the substrate thickness of the lens substrate 33 at the lower side as viewed in FIG. 1. As described above, the microlenses 34₁ to 34₃ are arranged in a line such that the substrate thickness of the lens substrate 33 at a portion corresponding to each of the microlenses 34₁ to 34₃ varies. In the first embodiment, the microlens 34₁ is located at a portion where the substrate thickness of the lens substrate 33 is the smallest. The microlens 34₃ is located at a portion where the substrate thickness of the lens substrate 33 is the greatest. The microlens 34₂ is located at a portion where the substrate thickness of the lens substrate 33 is intermediate between the smallest and the greatest. The microlenses 34₁ to 34₃ are formed by an ion exchange method, and form a lens area the cross-section of which is substantially semicircular and has a gradient index.

An outgoing end 32a of the optical fiber 32 is polished to have an inclined surface that has a predetermined angle, for example, eight degrees, with respect to a central axis of a core of the optical fiber 32 to prevent a reflected light from returning to the light source. The optical fiber 32 is retained by a capillary 35.

A procedure for manufacturing the optical module 30 such that the flat microlens array 31 and the optical fiber 32 are located apart from each other by a desired lens to optical fiber distance L will be explained. That is, a method for determining the position of the optical fiber 32 will be explained.

At first, the lens substrate 33 is processed such that the substrate thickness at a part of the lens substrate 33 corresponding to the middle microlens 34₂ is the optimal substrate thickness. The optimal substrate thickness refers to the substrate thickness at which the desired lens to optical fiber distance L is obtained in a state where the optical fiber 32 and the microlens 34₂ are arranged coaxial with each other, and the outgoing end 32a of the optical fiber 32 is brought close to the inclined surface 33b of the lens substrate 33 (see FIG. 1). The desired lens to optical fiber distance L is substantially the same as or less than the value of the focal distance f of the microlens.

The lens substrate 33 is processed by, for example, cutting and polishing. It is determined whether the substrate thickness of the portion of the lens substrate 33 corresponding to the microlens 34₂ is optimal, and whether the optical fiber 32 is located at a position where the lens to optical fiber distance is at a desired value L, by determining whether a measurement value of the maximum collimator length is at a target value.

The maximum collimator length is measured in a state where the optical fiber 32 is located at a position shown in FIG. 1. Then, it is determined whether the measurement value is at the target value. If the decision outcome is positive, that is, if the measurement value is at the target value, the optical module 30 is completed by integrating the optical fiber 32 and the lens substrate 33 of the flat microlens array 31 at that position.

On the other hand, if the decision outcome is negative, the optical fiber 32 is shifted upward or downward in parallel along the inclined surface 33b of the lens substrate 33. When measuring the maximum collimator length, if the optical fiber 32 is located at a position where the distance L′ between the lens substrate 33 and the optical fiber 32 is shorter than the lens to optical fiber distance L, the microlens 34₃ is selected and the optical fiber 32 is shifted upward to be coaxial with the microlens 34₃. Accordingly, the optical fiber 32 is located at a position where the lens to optical fiber distance L is optimal or substantially optimal. In this state, the optical fiber 32 and the lens substrate 33 of the flat microlens array 31 are integrated to form the optical module 30.

On the contrary, when measuring the maximum collimator length, if the optical fiber 32 is located at a position where the distance between the lens substrate 33 and the optical fiber 32 is longer than the predetermined lens to optical fiber distance L, the microlens 34₁ is selected and the optical fiber 32 is shifted downward to be coaxial with the microlens 34₁. Accordingly, the optical fiber 32 is located at a position where the lens to optical fiber distance L is optimal or substantially optimal. In this state, the optical fiber 32 and the lens substrate 33 of the flat microlens array 31 are integrated to form the optical module 30.

The first embodiment provides the following advantages.

(1) The substrate thickness between intersections of the optical axis of each of the microlenses 34₁ to 34₃ with the right end 33a and the inclined surface 33b, or the thickness of the lens substrate 33, differs depending on the microlens. Therefore, three different substrate thicknesses can be selected with one lens substrate 33. Accordingly, since the probability that the optimal substrate thickness can be selected without exchanging the lens substrate 33 increases, the rejection rate of the flat microlens array 31 is reduced and the yield rate is improved.

(2) Since the lens substrate 33 need not be processed with a strict accuracy, the processing cost is reduced, which results in reduction of the manufacturing cost of the flat microlens array 31.

(3) When forming the optical module by a combination of the optical fiber 32 and the flat microlens array 31, the variation of the lens to optical fiber distance L depending on each product of the optical module 30 is reduced. Accordingly, when using two pairs of the optical modules 30 to form the collimator optical device, the deviation of the maximum collimator length from the target value is reduced, and a high performance optical module is obtained.

FIG. 4 is an optical module 30A according to a second embodiment. The optical module 30A includes a microlens array, which is a flat microlens array 41, and an optical fiber array 42.

Microlenses 34₁₁ to 34ₘₙ are arranged in a two-dimensional matrix on a left end 43a of a lens substrate 43 of the flat microlens array 41. That is, the microlenses 34₁₁ to 34ₘₙ are arranged in seven lines, each including ten microlenses. The subscript “m” represents the number of rows of the microlenses. The subscript “n” represents the number of lines of the microlenses. The substrate thickness differs depending on each of first to seventh lines L1 to L7. On the other hand, the optical fiber array 42 includes five optical fibers 42₁ to 42₅ and a capillary 45, which retains the optical fibers 42₁ to 42₅.

A procedure for manufacturing the optical module 30A having the structure as mentioned above will now be described. That is, a method for determining the position of the optical fiber array 42 will be described.

At first, outgoing ends of the optical fibers 42₁₁ to 42₅ are located close to an inclined surface 43b of the lens substrate 43. In this state, while checking whether the measurement value of the maximum collimator length has reached the target value, the optical fiber array 42 is shifted in parallel in a direction represented by X shown in FIG. 4 along the inclined surface 43b of the optical fiber array 42 until the measurement value reaches the target value.

One line of microlenses is selected from the microlenses 34₁₁ to 34ₘₙ arranged in seven lines, which are the first to seventh lines L1 to L7, by shifting the optical fiber array 42 in the X-direction in parallel until the measurement value reaches the target value.

The positions of the optical fibers 42₁ to 42₅ of the optical fiber array 42 are determined with respect to the selected line of microlenses; for example, to the microlenses of the third line L3.

The optical fiber array 42 is then integrated with the flat microlens array 41 to form the optical module 30A.

The second embodiment formed as described above provides the following advantages in addition to the advantages (1) to (3) of the first embodiment.

(4) The flat microlens array 41 that is suitable for forming the optical module by combining the flat microlens array 41 with the optical fiber array 42, which has the optical fibers 42₁ to 42₅, is obtained.

(5) According to the microlenses arranged in a matrix, the substrate thickness differs depending on each of first to seventh lines L1 to L7. Thus, by selecting one of the lines of microlenses, the probability that the substrate thickness that is optimal for the optical fibers 42₁ to 42₅ is selected without changing the flat microlens array 41 is increased.

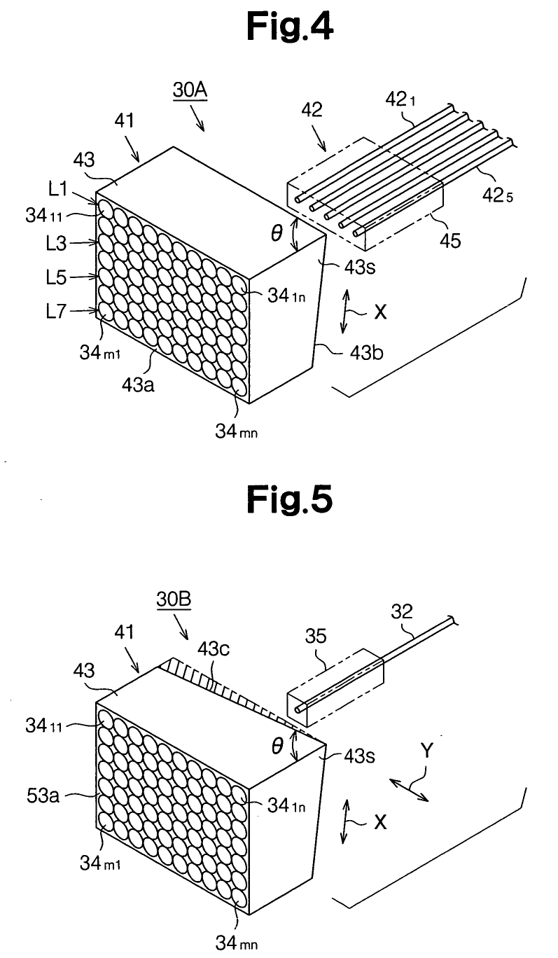

FIG. 5 shows an optical module 30B according to a third embodiment. The optical module 30B includes a microlens array, which is a flat microlens array 41 in the third embodiment, and an optical fiber 32. The optical module 30B has substantially the same structure as the optical module 30A of the second embodiment except that a shaded part of the lens substrate 43 shown in FIG. 5 is cut off such that the inclined surface 43b on the right end of the lens substrate 43 is tilted to form an inclined surface 43c. That is, the angle θ between the inclined surface 43c and a side wall 43s is less than 90 degrees. When the inclined surface 43b shown in FIG. 4 is assumed to be inclined in a first direction, the inclined surface 43c shown in FIG. 5 is inclined in a second direction that is different from the first direction.

Therefore, by shifting the optical fiber 32 in parallel along the inclined surface 43c in the X-direction and a Y-direction, a microlens that has the optimal substrate thickness is selected among the microlenses 34₁₁ to 34ₘₙ.

The third embodiment provides the following advantages in addition to the advantages of the second embodiment.

(6) The optical fiber 32 is shifted in parallel in the X-direction and the Y-direction along the inclined surface 43c until the measurement value reaches the target value. Accordingly, one of the microlenses 34₁ to 34ₙ that has the optimal substrate thickness is selected. Therefore, the range of the substrate thicknesses that can be selected is increased, which further increases the probability that the optimal substrate thickness can be selected.

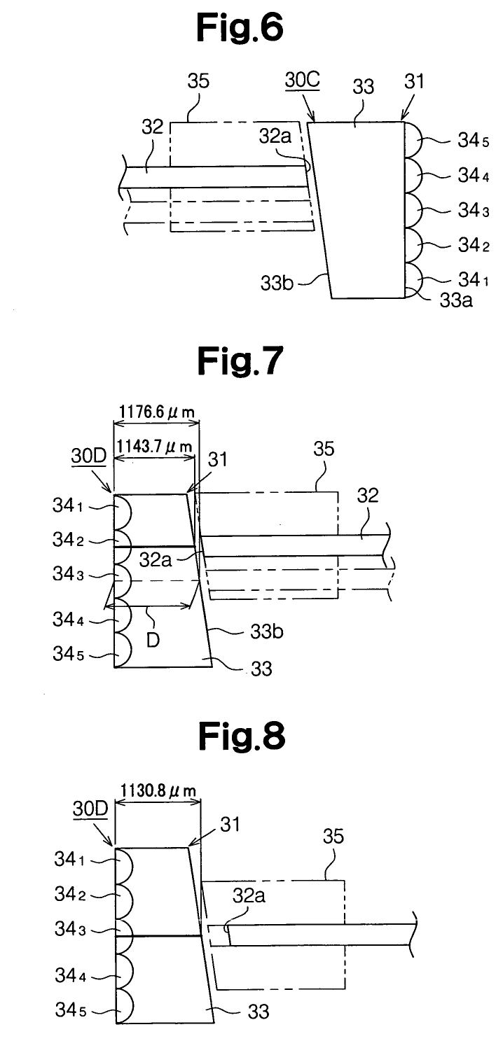

FIG. 6 shows an optical module 30C according to a fourth embodiment. The optical module 30C differs from the optical module 30 of the first embodiment in that five aspheric convex lenses, which are microlenses 34₁ to 34₅ in the fourth embodiment, are formed on the right end 33a of the lens substrate 33. Therefore, the fourth embodiment provides the same advantages as the first embodiment.

A method for determining the position of the optical module will be described with reference to FIGS. 7 and 8. An optical module 30D used in the description differs from the optical module 30 shown in FIG. 1 in that five microlenses 34₁ to 34₅ are formed on the lens substrate 33.

The lens substrate 33 of the optical module 30D shown in FIG. 7 is processed such that the substrate thickness (optimal substrate thickness) D at the center of the lens substrate 33, or at a portion corresponding to the microlens 34₃, is equal to the calculated value obtained in the following formula. That is, the calculated value is used as a target value when processing the lens substrate 33. In the following formula, the refractive index n of the microlens 34₃ (gradient index rod lens) is 1.523, the focal distance f is 700 μm, the wave length λ is 1.55 μm, and the field diameter w of the single mode optical fiber, which is the optical fiber 32, is 5.25 μm.

D=n(f+nw²/λ)=1151.2 μm

The target value D of the substrate thickness obtained from the above formula corresponds to the optimal substrate thickness.

Assume that the actual substrate thickness at the center of the lens substrate 33 is D′. A method for determining the position of the optical module when the actual substrate thickness D′ is greater than the target value D, which is 1151.2 μm, will be described with reference to FIG. 7. In the description, the actual substrate thickness D′ is assumed to be 1176.6 μm.

In step 1, the optical fiber 32 is located at a position such that the optical fiber 32 becomes coaxial with the center microlens 34₃ as shown by a chain double-dashed line in FIG. 7. The outgoing end of the optical fiber 32 is then brought closer to the inclined surface 33b.

In step 2, the maximum collimator length is measured at this position. At this time, since the actual substrate thickness D′ is greater than the target value D, the measurement value does not coincide with the target value of the maximum collimator length.

In step 3, the optical fiber 32 is shifted in parallel along the inclined surface 33b in a direction in which the substrate thickness decreases (upward as viewed in FIG. 7) until the optical fiber 32 becomes coaxial with the microlens 34₂. In step 3, when selecting one of the microlenses 34₁ to 34₅, the microlens 34₂ that is closest to and less than the optimal substrate thickness (target value D) is selected. This state is shown by a solid line in FIG. 7. Assume that the substrate thickness when the microlens 34₂ is selected is 1143.7 μm. In this case, the substrate thickness is less than the target value D by 7.5 μm.

In step 4, the optical fiber 32 is shifted apart from the inclined surface 33b of the lens substrate 33 by 7.5 μm from the position shown in FIG. 7 along the optical axis of the microlens 34₂. Accordingly, the optical fiber 32 is located at a position where the substrate thickness is equal to the target value D, that is, where the lens to optical fiber distance L is equal to the desired value. The optical module 30D is completed by integrating the optical fiber 32 and the flat microlens array 31 at this position.

A method for determining the position of the optical module when the actual substrate thickness D′ at the center of the lens substrate 33 is less than the target value D, which is 1151.2 μm, will be described with reference to FIG. 8. In the description, the substrate thickness D′ is assumed to be 1130.8 μm.

In this case, the optical fiber 32 is shifted apart from the inclined surface 33b of the lens substrate 33 by 20.4 μm along the direction of the optical axis of the microlens 343 from the state the optical fiber 32 is located coaxial with the center microlens 34₃. Accordingly, the optical fiber 32 is located at a position where the substrate thickness is equal the target value D, that is, where the lens to optical fiber distance L is equal to the desired value. The optical module 30D is completed by integrating the optical fiber 32 and the flat microlens array 31 at this position.

The method for determining the position of the optical module as described above provides the following advantages.

Although the optimal substrate thickness D (for example, 1151.2 μm) cannot be selected by selecting one of the microlenses 34₁ to 34₅, the optimal substrate thickness for the optical fiber 32 can be selected without changing the microlens array.

It should be apparent to those skilled in the art that the present invention may be embodied in many other specific forms without departing from the spirit or scope of the invention. Particularly, it should be understood that the invention may be embodied in the following forms.

In the first embodiment shown in FIG. 1, the number of microlenses of the lens substrate 33 may be greater than three. With this structure, the probability that the optimal substrate thickness can be selected without changing the lens substrate 33 is increased. Therefore, the rejection rate of the flat microlens array 31 is reduced and the yield rate is further improved.

In the above embodiments, the angle of the inclined surface 33b, 43b of the lens substrate 33, 43 need not be eight degrees. The angle may be minimized in a range that can prevent light from being reflected and returning to the light source, and the number of the microlenses may be increased so that the substrate thickness can be adjusted more finely by selecting one of the microlenses.

In the second embodiment shown in FIG. 4, the optical fiber array 42 has five optical fibers 42₁ to 42₅. However, the number of the optical fibers need not be five but may be changed as required.

In the second embodiment shown in FIG. 4, the optical fiber array 42 includes five optical fibers 42₁ to 42₁, which are arranged in a line. However, the present invention may be applied to the optical fiber array 42 in which optical fibers are arranged in two lines.

In the third embodiment shown in FIG. 5, one optical fiber 32 is provided. However, about three optical fibers 32 may be provided.

The present invention need not be applied to the flat microlens array of the above embodiments but may be widely applied to flat microlens arrays in which several microlenses are located on a transparent lens substrate one end of which is a flat surface that is perpendicular to an optical axis of each microlens and the other end of which is an inclined surface.

The present examples and embodiments are to be considered as illustrative and not restrictive and the invention is not to be limited to the details given herein, but may be modified within the scope and equivalence of the

1. A microlens array comprising:
a transparent lens substrate, wherein the transparent lens substrate has a first end and a second end, which are on opposite sides of the lens substrate, and wherein the second end is inclined with respect to the first end; and
a plurality of microlenses formed on the lens substrate to be located either inside or outside the first end, wherein each microlens has an optical axis, wherein the optical axis of each microlens intersects with the first end and the second end of the lens substrate at a first intersection and a second intersection, wherein the distance between the first and second intersections defines a substrate thickness, and wherein the substrate thickness differs depending on each microlens.

2. The microlens array according to claim 1, wherein the microlenses are arranged in a line along a direction in which the substrate thickness varies.

3. The microlens array according to claim 1, wherein the microlenses are arranged in a two-dimensional matrix.

4. The microlens array according to claim 1, wherein the first end is arranged to be perpendicular to the optical axis of each microlens.

5. The microlens array according to claim 4, wherein the second end is inclined with respect to the first end in more than one direction.

6. An optical module, which includes a microlens array and an optical fiber, wherein the microlens array and the optical fiber are located apart from each other by a desired lens to optical fiber distance,
wherein the microlens array includes:
a transparent lens substrate, wherein the transparent lens substrate has a first end and a second end, which are on opposite sides of the lens substrate, and wherein the second end is inclined with respect to the first end; and
a plurality of microlenses formed on the lens substrate to be located either inside or outside the first end, wherein each microlens has an optical axis, wherein the optical axis of each microlens intersects with the first end and the second end of the lens substrate at a first intersection and a second intersection, wherein the distance between the first and second intersections defines a substrate thickness, and
wherein the substrate thickness varies depending on each microlens,
wherein one of the microlenses is selected to optimize the substrate thickness, and wherein the position of the optical fiber is determined with respect to the selected microlens.

7. The microlens array according to claim 6, wherein the microlenses are arranged in a line along a direction in which the substrate thickness varies.

8. The microlens array according to claim 6, wherein the microlenses are arranged in a two-dimensional matrix.

9. The microlens array according to claim 6, wherein the first end is arranged to be perpendicular to the optical axis of each microlens.

10. The microlens array according to claim 9, wherein the second end is inclined with respect to the first end in more than one direction.

11. An optical module, which includes a microlens array and an optical array, wherein the optical array has a plurality of optical fibers, and wherein the microlens array and the optical fiber array are located apart from each other by a desired lens to optical fiber distance,
wherein the microlens array includes:
a transparent lens substrate, wherein the transparent lens substrate has a first end and a second end, which are on opposite sides of the lens substrate, and wherein the second end is inclined with respect to the first end; and
a plurality of microlenses formed on the lens substrate to be located either inside or outside the first end, wherein each microlens has an optical axis, wherein the microlenses are arranged in lines in a two-dimensional matrix, wherein the optical axis of each microlens intersects the first end and the second end of the lens substrate at a first intersection and a second intersection, wherein the distance between the first and second intersections defines a substrate thickness, and wherein the substrate thickness varies depending on each microlens,
wherein one of the lines of the microlenses is selected to optimize the substrate thickness, and wherein the position of the optical fiber array is determined with respect to the selected line of microlenses.

12. A method for determining the position of a microlens array and an optical fiber such that the microlens array and the optical fiber are apart from each other by a desired distance, the method comprising:
preparing the microlens array, wherein the microlens array includes a plurality of microlenses, which are located either inside or outside a first end of a lens substrate, wherein each microlens has an optical axis, wherein the optical axis of each microlens intersects the first end and a second end of the lens substrate at a first intersection and a second intersection, wherein the distance between the first and second intersections defines a substrate thickness, and
wherein the substrate thickness varies depending on each microlens;
selecting one of the microlenses to optimize the substrate thickness; and
determining the position of the optical fiber with respect to the selected microlens.

13. The method according to claim 12, wherein selecting one of the microlenses includes selecting one of the microlenses that corresponds to a portion of the lens substrate where the substrate thickness is closest to and less than the optimal substrate thickness, and
wherein determining the position of the optical fiber includes shifting the optical fiber along the optical axis of the selected microlens until the distance between the selected microlens and the optical fiber reaches the desired distance.
